(19) United States
(12) Patent Application Publication
(10) Pub. No.: US 2002/0129010 A1
(43) Pub. Date: Sep. 12, 2002

(54) System and method for processing user input from a variety of sources

(76) Inventors: Pascale Fung, Clear Water Bay (HK); Wai Kat Liu, Hong Kong (HK); Yiu Pong Lai, Hong Kong (HK); Wing Leung Ng, Tsueng Kwan O (HK); Wai Fung Pang, Kowloon Bay (HK); Kwok Leung Lam, Hong Kong (HK)

Correspondence Address: Chiahua George Yu, C. George Yu, Attorney, Ste. 210, 1250 Oakmead Pkwy., Sunnyvale, CA, 94085, US

(21) Appl. No.: 09/737,840

(22) Filed: Dec. 14, 2000

(51) Int. Cl. G06F 7/00

(52) U.S. Cl. 707/3

(57) ABSTRACT

A system and method is provided for responding to remotely-entered input from a plurality of technology platforms. An embodiment of the system includes a database that is configured to retrieve data in response to queries that are based on natural language; a first server that is configured to accept remotely-entered first natural-language input from a first technology platform and to determine a first query based on the first natural-language input and to obtain data from the database based on the first query; and a second server that is configured to accept remotely-entered second natural-language input from a second technology platform and to determine a second query based on the second natural-language input and to obtain data from the database based on the second query.

### RELATED APPLICATIONS

The present application is related to the following commonly-owned U.S. patent application(s), the disclosures of which are hereby incorporated by reference in their entirety, including any incorporations-by-reference, appendices, or attachments thereof, for all purposes:

Ser. No. 09/613,849, filed on Jul. 11, 2000 and entitled SYSTEM AND METHODS FOR DOCUMENT RETRIEVAL USING NATURAL LANGUAGE-BASED QUERIES; and

Ser. No. 09/613,472, filed on Jul. 11, 2000 and entitled “SYSTEM AND METHODS FOR ACCEPTING USER INPUT IN A DISTRIBUTED ENVIRONMENT IN A SCALABLE MANNER”.

### BACKGROUND OF THE INVENTION

The present invention relates to information processing. The present invention is especially relevant to systems and methods for processing user input that comes from a variety of technology platforms.

In the current information age, people want access to information services anytime and anywhere. There has been a proliferation of new technology platforms through which people can access information services across distant communication networks. For example, people can access information services via the World Wide Web (WWW) technology platform, via the Wireless Application Protocol (WAP) technology platform, and/or via the voice telephony technology platform, using automatic speech recognition.

What is needed are systems and methods that enable an information service provider to provide “anytime, anywhere” access to customers. For example, what is needed are such systems and methods that enable such an information service provider to provide an information service over each of several technology platforms while avoiding redundancies. What is also needed are such systems and methods that also facilitate advanced and possibly platform-dependent user interface modalities for each technology platform while retaining some level of similarity between the user interface modalities, especially with respect to user input methods and characteristics. What is especially needed are such systems and methods that are operative for user input that includes words of Chinese, Japanese, or similar languages. The present invention satisfies these and other needs.

### SUMMARY OF THE INVENTION

According to an embodiment of the present invention, a system for responding to remotely-entered input includes a database that is configured to retrieve data in response to queries that are based on natural language; a first server that is configured to accept remotely-entered first natural-language input from a first technology platform and to determine a first query based on the first natural-language input and to obtain data from the database based on the first query; and a second server that is configured to accept remotely-entered second natural-language input from a second technology platform and to determine a second query based on the second natural-language input and to obtain data from the database based on the second query.

According to another embodiment of the present invention, a system for responding to remotely-entered input includes a database; a first server that is configured to accept remotely-entered first input from a first technology platform, wherein the first input includes input derived from manually-entered input, and the manually-entered input is for indicating a user-composed set of words; and a second server that is configured to accept remotely-entered second input from a second technology platform, wherein the second input includes input derived from speech; wherein the first server or the second server is configured to recognize words from the first input or from the second input, respectively, and to obtain and output data from the database based on the recognized words.

According to another embodiment of the present invention, a method for responding to remotely-entered input includes the steps of maintaining a database that is capable of providing stored data in response to queries; accepting first natural-language user input from a first technology platform; determining a first query based on the first natural-language input; providing data from the database based on the first query; accepting second natural-language user input from a second technology platform; determining a second query based on the second natural-language input; and providing data from the database based on the second query.

### BRIEF DESCRIPTION OF THE DRAWINGS

FIG. 1 is a schematic diagram for a conventional or general-purpose computer system, such as an IBM-compatible personal computer (PC) or server computer or other similar platform, that may be used for implementing the present invention.

FIG. 2 is a schematic diagram for a software system for controlling the computer system of FIG. 1.

FIG. 3 is a schematic diagram for a system according to the present invention.

FIG. 4 is a schematic diagram for an embodiment of the system of FIG. 3.

FIG. 5 is a flow diagram that illustrates an exemplary method for responding to user input across multiple platforms.

FIG. 6 is a schematic diagram of an embodiment of the telephone customer servers of FIGS. 3 or 4.

### DETAILED DESCRIPTION OF A PREFERRED EMBODIMENT

The following description will focus on the currently-preferred embodiment of the present invention, which is operative in an environment typically including personal computers (PCs), server computers, wireless or wireline telephones, personal digital assistants, and other types of information appliances. The currently-preferred embodiment of the present invention may be implemented in an application operating in an Internet-connected and telephony-connected environment and running under an operating system, such as the Linux operating system, on an IBM-compatible Personal Computer (PC) configured as an Internet server or client. The present invention, however, is not limited to any particular environment, device, or application. Instead, those skilled in the art will find that the present invention may be advantageously applied to other environments or applications. For example, the present invention may be advantageously embodied on a variety of different platforms, including Microsoft® Windows, Apple Macintosh, EPOC, BeOS, Solaris, UNIX, NextStep, and the like. Therefore, the description of the exemplary embodiments which follows is for the purpose of illustration and not limitation.

I. Computer-based Implementation

A. Basic System Hardware (e.g., for Server or Client Computers)

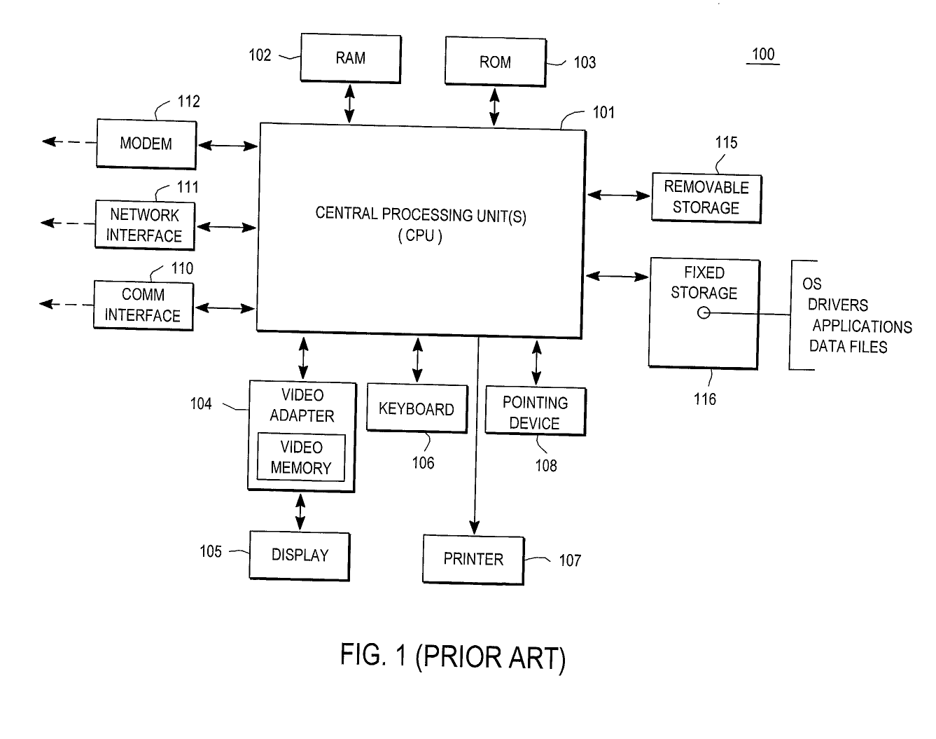

The present invention may be implemented using conventional or general-purpose computer system(s), such as an IBM-compatible personal computer (PC) configured to be a client or a server computer. FIG. 1 is a schematic diagram for an IBM-compatible computer system 100. As shown, the computer system 100 comprises a central processor unit(s) (CPU) 101 coupled to a random-access memory (RAM) 102, a read-only memory (ROM) 103, a keyboard 106, a pointing device 108, a display or video adapter 104 connected to a display device 105 (e.g., cathode-ray tube, liquid-crystal display, and/or the like), a removable (mass) storage device 115 (e.g., floppy disk and/or the like), a fixed (mass) storage device 116 (e.g., hard disk and/or the like), a communication port(s) or interface(s) 110, a modem 112, and a network interface card (NIC) or controller 111 (e.g., Ethernet and/or the like). Although not shown separately, a real-time system clock is included with the computer system 100, in a conventional manner.

CPU 101 comprises a processor of the Intel Pentium® family of microprocessors. However, any other suitable microprocessor or microcomputer may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory (RAM) 102 serves as the working memory for the CPU 101. In a typical configuration, RAM of at least sixty-four megabytes is employed. More or less memory may be used without departing from the scope of the present invention. The read-only memory (ROM) 103 contains the basic input output system code (BIOS)—a set of low-level routines in the ROM 103 that application programs and the operating systems can use to interact with the hardware, including reading characters from the keyboard, outputting characters to printers, and so forth.

Mass storage devices 115 and 116 provide persistent storage on fixed and removable media, such as magnetic, optical or magnetic-optical storage systems, or flash memory, or any other available mass storage technology. The mass storage may be shared on a network, or it may be a dedicated mass storage. As shown in FIG. 1, fixed storage 116 stores a body of programs and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the storage device or mass storage 115 and 116 into the main memory (RAM) 102, for execution by the CPU 101. During operation of the program logic, the computer system 100 accepts, as necessary, user input from a keyboard 106, a pointing device 108, or any other input device or interface. The user input may include speech-based input for or from a voice recognition system (not specifically shown and indicated). The keyboard 106 permits selection of application programs, entry of keyboard-based input or data, and selection and manipulation of individual data objects displayed on the display device 105. Likewise, the pointing device 108, such as a mouse, track ball, pen device, or the like, permits selection and manipulation of objects on the display device 105. In this manner, the input devices or interfaces support manual user input for any process running on the computer system 100.

The computer system 100 displays text and/or graphic images and other data on the display device 105. The display device 105 is driven by the video adapter 104, which is interposed between the display 105 and the system. The video adapter 104, which includes video memory accessible to the CPU, provides circuitry that converts pixel data stored in the video memory to a raster signal suitable for use by a cathode ray tube (CRT) raster or liquid crystal display (LCD) monitor. A hard copy of the displayed information, or other information within the computer system 100, may be obtained from the printer 107, or other output device. Printer 107 may include, for instance, a Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The computer system 100 may also communicate with local occasionally-connected devices (e.g., serial cable-linked devices) via the communication interface 110, which may include a RS-232 serial port, a serial IEEE 1394 (formerly, “firewire”) interface, a Universal Serial Bus (USB) interface, or the like. Devices that will be commonly connected locally to the communication interface 110 include other computers, handheld organizers, digital cameras, and the like. The system may accept any manner of input from, and provide output for display to, the devices with which it communicates.

The above-described computer system 100 is presented for purposes of illustrating basic hardware that may be employed in the system of the present invention. The present invention however, is not limited to any particular environment or device configuration. Instead, the present invention may be implemented in any type of computer system or processing environment capable of supporting the methodologies of the present invention presented in detail below.

B. Basic System Software

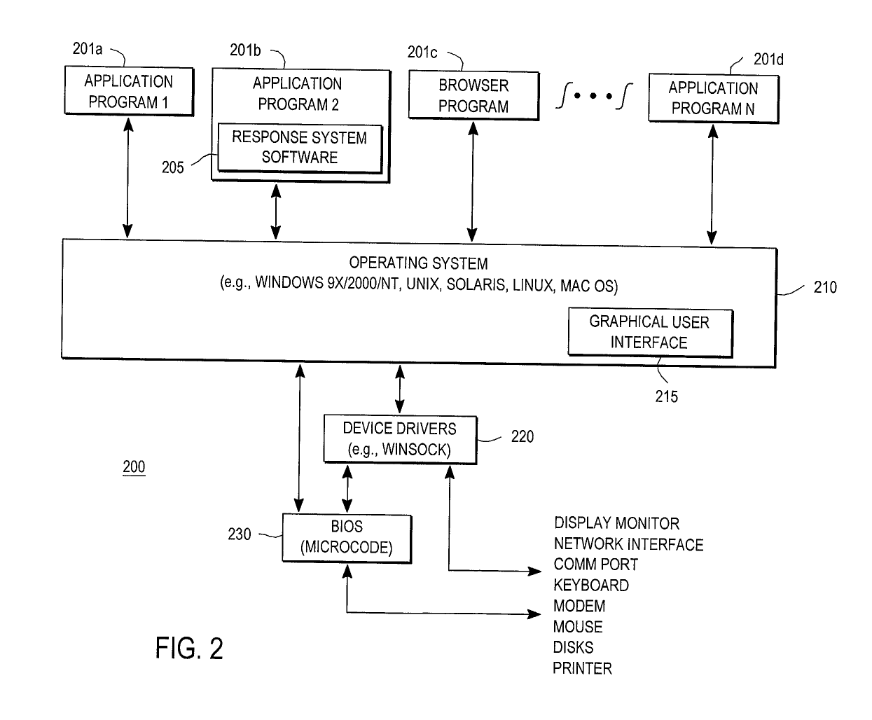

FIG. 2 is a schematic diagram for a computer software system 200 that is provided for directing the operation of the computer system 100 of FIG. 1. The software system 200, which is stored in the main memory (RAM) 102 and on the fixed storage (e.g., hard disk) 116 of FIG. 1, includes a kernel or operating system (OS) 210. The OS 210 manages low-level aspects of computer operation, including managing execution of processes, memory allocation, file input and output (I/O), and device I/O. One or more application programs, such as client or server application software or “programs” 201 (e.g., 201a, 201b, 201c, 201d) may be “loaded” (i.e., transferred from the fixed storage 116 of FIG. 1 into the main memory 102 of FIG. 1) for execution by the computer system 100 of FIG. 1.

The software system 200 preferably includes a graphical user interface (GUI) 215, for receiving user commands and data in a graphical (e.g., “point-and-click”) fashion. These inputs, in turn, may be acted upon by the computer system 100 in accordance with instructions from the operating system 210, and/or client application programs 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver) and the system BIOS microcode 230 (i.e., ROM-based microcode), particularly when interfacing with peripheral devices. The OS 210 can be provided by a conventional operating system, such as a Unix operating system, such as Red Hat Linux (available from Red Hat, Inc. of Durham, N.C., U.S.A.). Alternatively, OS 210 can also be another conventional operating system, such as Microsoft® Windows 9x or 2000 or NT (all of which are available from Microsoft Corporation of Redmond, Washington, U.S.A.) or a Macintosh OS (available from Apple Computers of Cupertino, Calif., U.S.A.).

Of particular interest, the application program 201b of the software system 200 includes software code 205 according to the present invention for providing a response system that handles user input. Construction and operation of embodiments of the present invention, including supporting methodologies, will now be described in further detail.

II. Overview of the Response System

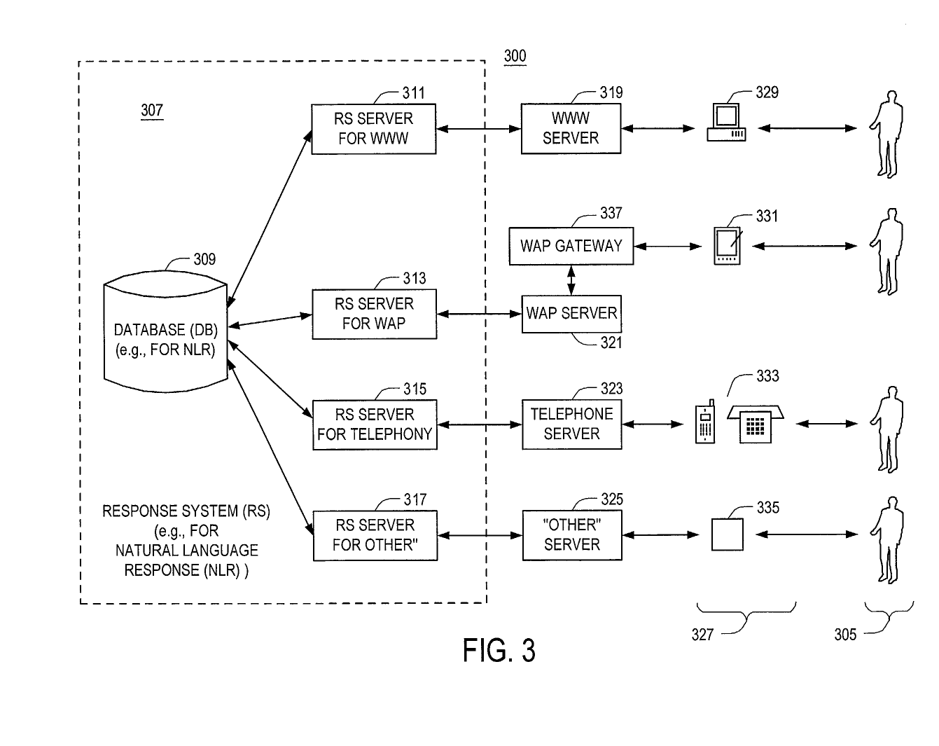

FIG. 3 is a schematic diagram for a system 300 according to the present invention. The system 300 provides responses to a set of one or more end users 305. In the currently-preferred embodiment of the system 300, the system 300 provides language-based responses to user input. For example, the system 300 preferably provides a facility for manual and/or speech-based entry of text, preferably natural-language text, by a user. The system 300 provides such text-entry by providing text in response to user input. The user input somehow specifies or indicates the text intended to be entered. The system 300 may further provide responses to the entered text. For example, the system 300 preferably provides responses in the form of retrieved documents, for example, as an online search engine, in response to an entered natural-language query. The manual and/or speech-based text entry (preferably, natural-language text entry) is preferably provided as described in the incorporated, commonly-owned, and co-pending U.S. patent application Ser. No. 09/613,472, entitled “SYSTEM AND METHODS FOR ACCEPTING USER INPUT IN A DISTRIBUTED ENVIRONMENT IN A SCALABLE MANNER”, hereinafter referred to as USER INPUT REFERENCE. The document retrieval is preferably provided as described in the incorporated, commonly-owned, and co-pending U.S. patent application Ser. No. 09/613,849, entitled “SYSTEM AND METHODS FOR DOCUMENT RETRIEVAL USING NATURAL LANGUAGE-BASED QUERES”, hereinafter referred to as DOCUMENT RETRIEVAL REFERENCE.

The system 300 includes a response system (RS) 307, which is preferably a natural language (NL) response (NLR) system 307 that provides language-based responses, as discussed above. The NLR system 307 includes a database 309 and one or more of response system servers 311, 313,315, and 317 (RS servers). The RS servers 311,313, 315, and 317 provide RS services to customer servers 319, 321, 323, and 325, respectively. The customer servers 319, 321, 323, and 325 provide actual user sessions to the end users 305, via user information access devices 327 (e.g., information appliances). Each customer server 319, 321, 323, or 325 accepts input from one of the end user(s) 305 and then packages and sends such input to one of the RS servers 311, 313, 315, or 317 and then receives a response from the RS server that received the input. In general, the word “server” is used to mean an entity, typically, a software program, that provides some service to other (client) entities, typically, other software programs. Occasionally, as indicated by context, the word “server” may used to refer to a computer that provides services.

The information access devices 327 may include, for example, a personal computer 329, a personal digital assistant (PDA) 331, a telephone 333 (wireless or wireline), or some other information appliance 335 that has communication capabilities. Communications between the RS servers, the customer servers, and the information access devices 327 may be facilitated and mediated by gateways or other intermediate computing entities. For example, a gateway(s) 337 may facilitate and mediate communications between the customer server 321 and the information access device 331 (a PDA). The customer servers 319, 321, 323, and 325 preferably provide their services over a distant communications network, such as the Internet, preferably to other geographic locations, for example, locations that are more then ten, or more than a hundred, kilometers away. The RS servers 311, 313, 315, and 317 may also provide their services over a distant communications network, such as the Internet.

By way of example, in FIG. 3, the RS server 311 is a server that provides RS services to World Wide Web (WWW) server(s), including the customer server 319 which may be, for example, a WWW portal. The RS server 313 is a server that provides RS services to WAP (Wireless Application Protocol) servers, including the customer server 321 which may be, for example, a WAP portal. The gateway 337 is preferably a WAP gateway. WAP gateways are available from, for example, Openwave Systems, Inc., or Nokia Corp. (Openwave Systems, Inc. is headquartered in Redwood City, Calif., U.S.A. Nokia Corp. is headquartered in Finland.) The RS server 315 is a server that provides RS services to telephone servers, including the customer server 323 which is, for example, a voice portal. The RS server 317 is any other type of server, for example, one that provides RS services to the customer server 325 which may be, for example, a server across a private network such as an intranet or the like. The RS server 317 may use proprietary or special-purpose protocols to communicate with the customer server 325. The customer server 325 may be a server on a point-of-sale network, field agents' network, a virtual private network (VPN), or the like. In general, though, the RS servers 311, 313, 315, and 317 preferably use standard protocols, preferably including TCP/IP (Transmission Control Protocol over Internet Protocol), to communicate with the customer servers or gateways to which the RS servers 311, 313, 315, and 317 provide service.

The database 309 is preferably configured to provide information and services according to a pre-specified interface, for example, in response to queries. RS servers 311, 313, 315, and 317 access the database 309 according to the database 309's interface. In turn, each of the RS servers 311, 313, 315, and 317 provides services (e.g., text-entry and/or document-retrieval services) according to some interface that is appropriate for the particular RS server. For example, the RS server 311 for the WWW technology platform provides its services via an interface that is suitable for use over the Internet by a WWW server such as the WWW server 319. For example, the RS server 313 for the WAP technology platform provides its services via an interface that is suitable for use via a WAP gateway 337 by a WAP server such as the WAP server 321. For example, the RS server 315 for the telephony technology platform provides its services via an interface that is suitable for use via a network connection by a telephone server such as the telephone server 323.

The response system 307 is configured so that new types of RS servers may be designed and built to provide services using new interfaces, all without requiring that the database 309 change its interface. In particular, the new types of RS servers may be designed and built subsequent to the building of the database 309. The interfaces used by the RS servers may be specified to include use of any technology or standard, for example, HTTP (Hyper-Text Transfer Protocol), WAP, HTML (Hyper-Text Markup Language), TCP/IP, XML (extensible Markup Language), SGML (Standard Generalized Markup Language), Java, Javabeans, and/or the like.

The servers 311 and 319 for WWW preferably together accept and process manually-entered input from a user and preferably respond to the user with visual output, e.g., in a document defined in HTML. Similarly, the servers 313 and 321/337 for WAP preferably together accept and process manually-entered input from a user and preferably respond to the user with visual output, e.g., in a document defined in WML (Wireless Markup Language). (WML is a part of WAP.) The servers 315 and 323 for telephony preferably together accept and process spoken input (audio) from a user and preferably respond to the user with audio output. Optionally, the servers 311 and 319 together for WWW and/or the servers 313 and 321/337 together for WAP are configured also to accept and process spoken input, for example, via a microphone at the user's client device 329 or 331, and to respond to such input with either visual output or audio output or a combination of visual and audio output.

Manually-entered input may include, for example, typed input, pen-based input, other touch-based input, and the like. The user-input facility at the client device for manually-entered input may include, for example, a physical keyboard, a logical keyboard that is shown on a touch-screen, a pen-based input interface, such as a pen-writing recognition interface, or any other input device or facility that accepts touch-based, motion-based, gesture-based, or other manual input from a user. A pen-writing recognition interface may, for example, be an interface that automatically recognizes pen-written English letters or an interface such as Graffiti that automatically recognizes gesture-based abbreviations of English letters, or the like. Graffiti is the well-known text entry system used by the Palm family of personal digital assistants (PDAs), which are available from Palm Computing of Santa Clara, Calif., U.S.A.

As mentioned above, FIG. 3 is a schematic diagram. FIG. 3 describes logical elements of the system 300 and logical relationships between the logical elements. It should be understood that the elements of FIG. 3 may be embodied using various different actual hardware and software configurations. For example, the entire response system 307, including its multiple RS servers 311, 313, 315, and 317, may be implemented on a single server computer that includes appropriate peripherals such as telephony interface cards. Alternatively, the response system 307 may be implemented on multiple connected computers, for example, one or more computers just for the database 309 and one or more computers just for each of the RS servers 311, 313, 315, and 317. Other configurations are also possible. For example, in one embodiment of the present invention, the WWW customer server 319 may implemented on a same computer as the RS Server 311 for WWW, and the telephone customer server 323 may implemented on a same computer as the RS Server 315 for telephony.

III. Further Details of an Exemplary Response System

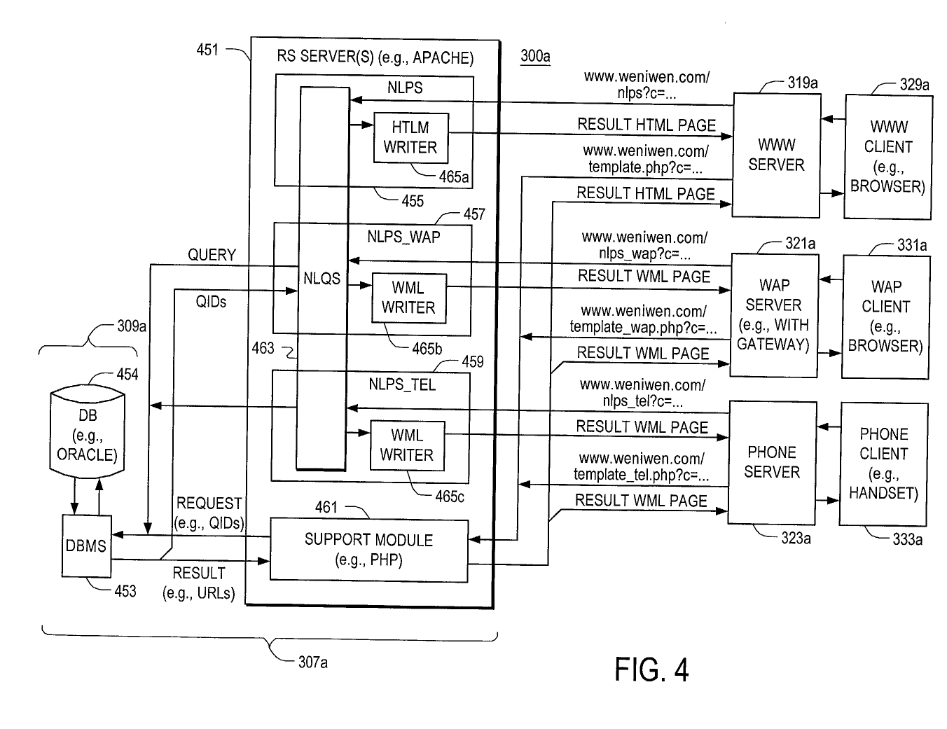

FIG. 4 is a schematic diagram for an embodiment 300a of the system 300 of FIG. 3. The system 300a includes an NLR system 307a, which includes a central database 309a, and an RS server 451. The RS server 451 is shown as being capable of providing services to a WWW customer server 319a, a WAP customer server 321 a (e.g., including a WAP gateway), and a telephone customer server 323a. The RS server 451 includes or embodies each of the RS servers 311, 313, and 315 of FIG. 3. The RS server 451 may also include or embody the RS server 317 of FIG. 3, but for economy of description, no embodiment of the RS server 317 of FIG. 3 is specifically shown in FIG. 4. The customer servers 319a, 321a, and 323a include or embody the customer server 319, the customer server/gateway 321/337, and the customer server 323, of FIG. 3, respectively. The customer servers 319a, 321a, and 323a provide user sessions to end-users via a WWW client 329a (e.g., a WWW browser), a WAP client 331a (e.g., a WAP browser), and a telephone client 333a (e.g., a telephone), respectively.

Multiple instances of the RS server 451 might exist, in order to provide services to a great number of customer servers and end users. The multiple instances might each include or embody fewer than all of the RS servers 311, 313, and 315 of FIG. 3. For example, three instances of the RS server 451 might each respectively embody exactly one of the RS servers 311, 313, and 315 (and 317) of FIG. 3. The multiple instances preferably together access only a single instance of the database 309a.

FIG. 4 includes depiction of portions of exemplary information that may be communicated at certain times between elements of the system 300a. The depicted exemplary information are not meant to exhaustively list all types of information that may be communicated between elements of the system 300a. The flow of information through the system 300a is further discussed in a later section connection with an example user session.

The database 309a is preferably a server that includes a database management system (DBMS) 453 that provides access to data stored in a database subsystem 454, which may be implemented using any suitable database program, such as Oracle 8, which is available from Oracle Corp. of Redwood Shores, Calif., U.S.A. The database 309a is configured for providing information services. In particular, the database 309a includes information that can be provided in response to a query, preferably a natural-language query, that is somehow obtained from an end user as well as information used in determining the information to be provided. The response system 307a preferably includes a document-retrieval system (e.g., search engine), preferably one as described in the incorporated DOCUMENT RETRIEVAL REFERENCE. In connection with this included document retrieval system, the database 309a may include, for example, documents, or pointers to documents, that can be provided in response to an end user's document search request. The database 309a may also include indexing data for the search engine. The indexing data may include, for example, a database of pre-stored “queries” or abstracts, along with pointers to the documents that best respond to, or correspond with, each pre-stored query or abstract. In responding to a user query, the DBMS 453 would find the pre-stored query(ies) that is (are) most semantically similar to the user query and then return the pointers to documents that best correspond with each pre-stored query, as is further discussed in the incorporated DOCUMENT RETRIEVAL REFERENCE.

The response system 307a may also (or alternatively) include a text-entry system, preferably one that accepts both speech-derived input and manually-entered input that preferably may contain mixed Chinese/English natural-language content, as described in the incorporated USER INPUT REFERENCE. In connection with this text-entry system, the database 309a may include language models and/or other data for the text-entry system. The user input for this text-entry system may be in the form of speech sounds (for example, from a telephone or microphone-equipped computer) or in the form of speech sound labels (for example, Chinese pinyin syllable labels) that are either typed by an end user or generated from the end user's speech by a limited front-end automatic speech-to-subword recognizer, as is further described in the incorporated USER INPUT REFERENCE.

The RS server 451 is preferably a WWW server. The RS server 451 preferably includes a platform-dependent module, or (sub)system, for each technology platform that is supported by the RS server 451. For example, the RS server 451 may include a WWW module 455, a WAP module 457, and a telephony module 459, as is shown in FIG. 4A. The platform-dependent modules 455, 457, and 459 are preferably configured to process natural-language query input and to respond with a search result based on the input natural-language query. Thus, the platform-dependent modules 455, 457, and 459 are examples of natural language-processing search (NLPS) modules or (sub)systems. The RS server 451 preferably also includes one or more support module(s) 461 that provides other services, perhaps in a platform-neutral or in a multi-platform manner. The preferred platform-dependent NLPS modules 455, 457, and 459 each obtains services from a natural language query search (NLQS) module, or (sub)system. Preferably, a single platform-independent NLQS module 463 is used in common by the platform-dependent NLPS modules 455, 457, and 459. However, in an alternative embodiment, individual ones of the platform-dependent NLPS modules 455, 457, and 459 may instead include their own platform-dependent NLQS modules (not shown in FIG. 4). The database 309a, or at least its DBMS 453, together with the platform-independent NLQS module 463 may be considered to be an NLQS system, namely a platform-independent or multi-platform NLQS system. The WWW module 455 includes an HTML output writer, or module, 465a. The preferred WAP module 457 includes an WML output writer 465b. The preferred telephony module 459 includes an WML output writer 465c.

In the alternative embodiment mentioned above, the platform-dependent NLQS modules may be embodied by separate instances of a common piece of software such that each instance is instantiated to be suitable for its own platform(s) via platform-specific flags and other settings. The platform-dependent NLQS modules preferably handle substantially all of any platform-dependent aspects of the user input that reaches the RS server 451 (i.e., any aspects that have not been, or could not be, already handled by the platform-dependent customer servers 319a, 321a, and 323a). Thus, the DBMS 453 needs only deal with its pre-established interface that is preferably platform-independent. The database 309a, or at least its DBMS 453, together with any of the platform-dependent NLQS modules may be considered to be an NLQS system. The database 309a, or at least its DBMS 453, in that scenario is a platform-independent core of such an NLQS system, and the platform-dependent NLQS modules are platform-dependent front-ends of such an NLQS system. Such an NLQS system may be a multi-platform system.

The RS server 451 may be implemented using, for example, the widely-available, open-source Apache HTTP server software. The support module(s) 461 may be implemented using, for example, the PHP scripting language, which is a widely-available, open-source, server-side, cross-platform, HTML-embedded scripting language used to create dynamic web pages. The platform-dependent modules 455, 457, 459 together may be considered to be a multi-platform module, and the RS server 451 itself may be considered to be a multi-platform server if it includes more than one of the platform-dependent modules 455, 457, and 459. Each of the platform-dependent NLPS modules 455, 457, and 459 is preferably configured to process input that is in a form that may be dependent on a particular platform and then to respond to that input in a platform-dependent manner. The platform-dependent NLPS modules 455, 457, and 459 each communicates with the database 309a, however, in a non-platform-dependent manner, as was further discussed above.

IV. Methodology of the Exemplary Response System

A. An Example User Session via the WWW Platform

An example of a user session via the WWW client 329a (browser) is as follows. The user manually enters a natural-language query into his information appliance. For example, the user types the query into a text-entry field of a web page (HTML) that was provided by the WWW customer server 319a. The query may be entered using a text-input facility that is separate from the system 300a, for example, according to a first scenario in which the text-input facility is provided natively by the user's information appliance. In the just-described first scenario, the query is preferably sent by the WWW client 329a to the WWW customer server 319a as text, e.g., using a standard text encoding scheme such as ASCII (for English text), or “GB” or “Big5” (for Chinese character text), or the like. Alternatively, the query may be entered according to a second scenario using a text-input method that is to be provided at least in part by the system 300a itself. In the just-described second scenario, the query is sent by the WWW client 329a not as fully-defined text. Instead, in the just-described second scenario, the query is sent by the WWW client 329a in an intermediate or ambiguous form to the WWW customer server 319a for further processing into text. An example of an intermediate or ambiguous form of user input is a sequence of Chinese syllables, spelled out using ASCII-encoded English letters according to the standard pinyin syllable set of China. Such a syllable sequence is not yet fully-defined text in the intended language (e.g., is not yet in the form of a specific sequence of Chinese characters for the Chinese language). See the incorporated DOCUMENT RETRIEVAL REFERENCE for further description of the preferred text input methodology that is provided by the system 300a.

The WWW customer server 319a receives the user query as described above and, based on the user query, requests a response from the RS server 451. For example, the WWW customer server 319a produces an invocation of a service using the user query, in text format or intermediate/ambiguous format, as the input data for the invocation. The invocation includes an address, e.g., “www.weniwen.com”, by which the RS server 451 may be reached. The invocation indicates the technology platform (e.g., WWW, or HTML) of the invoking WWW customer server 319a. For example, the invocation includes an identifier, such as a string “nlps?c=”, that indicates that the user input is of a type from a WW-platform customer server and is for handling by the WWW-dependent NLPS module 455. The NLQS module 463 (or a platform-dependent NLQS module, as discussed above) of the WWW NLPS module 455 converts the user query, which may be platform-dependent, into a platform-neutral form as necessary. The NLQS module 463 (or the platform-dependent NLQS module) submits the platform-neutral form of the user query to the database 309a according to the database 309a's interface.

An example of a platform-dependent form of the user query, as discussed above, is a user query in an intermediate or ambiguous form. Such a user query is platform-dependent, for example, because the form of the user query may depend on the capabilities of the particular technology platform in question, for example, on whether the platform supports speech input, pinyin-sentence input, or both, or neither. An example of a platform-neutral form of the user query is a user query in text form, if the database 309a's interface, which is platform-neutral, specifies text as a supported query form. Thus, an example of converting a platform-dependent form into a platform-neutral form is converting the intermediate or ambiguous form of the query into its corresponding text form(s), as is further discussed in the incorporated USER INPUT REFERENCE.

The database 309a receives the user query (preferably in platform-neutral form) as described above and determines a response to the user query and communicates the response to the NLQS module 463. For example, the response may include a list of alternative interpretations of the user query, from which the user is ultimately supposed to select the intended interpretation. Under the example, in the preferred embodiment of the invention, each alternative interpretation preferably corresponds to a pre-stored query or abstract and is in the form of a query identifier (QID) that identifies the pre-stored query or abstract in the database 309a. Under the example, in the preferred embodiment of the invention, the response may further include one or more pointers to relevant documents or resources for each alternative interpretation. Such pointers may be in the form of Uniform Resource Locators (URLs), or any other address or identifier of a document or resource. The HTML output writer 465a creates a platform-dependent result page (e.g., HTML page) that includes the response from the database 309a. For example, the platform-independent NLQS module 463 preferably presented the result to the HTML output writer 465a in a platform-independent form, for example, using XML, and the HTML output writer 465a preferably converted the platform-independent form (e.g., XML) into a platform-dependent form (e.g., HTML). The HTML output writer 465a sends the result page to the WWW customer server 319a.

The Www customer server 319a receives the result page as described above. The WWW customer server 319a presents the result page (or at least its information) to the user via the user's WWW client 329a (browser). The WWW customer server 319a provides for user interaction based on the information of the result page, and may invoke the RS server 451 for further responses based on the information of the result page. For example, consider the following example scenario. The result page includes a list of alternative interpretations of the original user query. The WWW customer server 319a displays these alternatives to the user via the user's WWW client 329a (browser). The user interactively chooses one of the alternatives as being the intended interpretation, or at least being most similar to the intended interpretation. The user makes the choice, for example, by scrolling through the alternatives as necessary and clicking an on-screen button displayed next to the intended alternative. The scrolling may include scrolling among a list of sentences and/or scrolling among a pop-up list of alternative words that can instantiate a word class in a sentence template, as is further discussed in the incorporated DOCUMENT RETRIEVAL REFERENCE. In response to the user choice, the WWW customer server 319a displays the response (for example, pointer(s) to document(s)), from the database 309a, that is appropriate for the actually-intended alternative.

The response for the actually-intended alternative may have arrived to the WWW customer server 319a within the result page that was already received from the database 309a. Alternatively, the WWW customer server 319a may obtain the response after the user selects the actually-intended interpretation, via a separate exchange with the RS server 451. The separate exchange may include, for example, the WWW customer server 319a's sending the QID that corresponds to the actually-intended alternative to the support module 461 of the RS server 451 in order to request and obtain the URL(s) for the document(s) that correspond to the QID. In the separate exchange, the request may specifically identify the platform (namely WWW) of the WWW customer server 319a so that the support module 461 will obtain the URL(s) from the database 309a in a platform-neutral form and then convert or package URL(s) into a corresponding platform-dependent result page (e.g., HTML page). For example, the request may include an identifier, such as a string “template-b5.php?c=”, that specifies that result is to be presented in a WWW-dependent format (e.g., HTML).

B. An Example User Session via the WAP Platform

An example of a user session via the WAP client 33 1a (WAP browser) is largely similar to the example of a user session via the WWW client 329a (browser) that has just been discussed in the preceding paragraphs. The difference is that, in the user session via the WAP client 331a, WAP-dependent elements of the system 300a are employed instead of those elements' WWW-dependent analogs. The WAP-dependent elements that are employed are the WAP customer server 321a, the NLPS module 457 for WAP, any platform-dependent (e.g., WAP-specific) NLQS module, and the WML writer 465b. The WWW analogs of the WAP-dependent elements are the elements 319a, 455, 463 (or a WWW-specific NLQS module), and 465a, respectively. Communications between the WAP customer server 321a and the RS server 451 include indicators that the WAP technology platform is involved. For example, in invoking a service from the RS server 451 based on a user query, the WAP customer server 321 a sends an identifier, such as a string “nlps_wap?c=”, that indicates that the user input is of a type from a WAP-platform customer server and is for handling by the WAP-dependent NLPS module 457. For another example, in obtaining a response to an actually-intended interpretation of the user input, the WAP customer server 321a may send an identifier, such as a string “template_wap.php?c=”, that specifies that result is to be presented in a WAP-dependent format (e.g., WML).

C. An Example User Session via the Telephony Platform

An example of a user session via the telephone client 333a (e.g., telephone) is largely similar to the example of a user session via the WWW client 329a (browser) that has just been discussed in the preceding paragraphs. The difference is that, in the user session via the telephone client 333a, telephony-dependent elements of the system 300a are employed instead of those elements' WWW-dependent analogs. The telephony-dependent elements that are employed are the telephone customer server 323a, the NLPS module 459 for telephony, any platform-dependent (e.g., telephony-specific) NLQS module, and the WML writer 465c. The WWW analogs of the telephony-dependent elements are the elements 319a, 455, 463 (or a telephony-dependent NLQS module), and 465a, respectively. Communications between the telephone customer server 323a and the RS server 451 include indicators that the telephony technology platform is involved. For example, in invoking a service from the RS server 451 based on a user query, the telephone customer server 323a sends an identifier, such as a string “nlps_tel?c=”, that indicates that the user input is of a type from a telephony-platform customer server and is for handling by the telephony-dependent NLPS module 457. For another example, in obtaining a response to an actually-intended interpretation of the user input, the telephone customer server 323a may send an identifier, such as a string “template_tel.php?c==”, that specifies that result is to be presented in a telephone-dependent format. According to an interface for the RS server 451 for the telephony platform, the telephone-dependent format is WML, with the understanding that the telephone customer server 323a will convert the WML-format result into a suitable form for telephony applications. The telephone customer server 323a preferably takes voice input from the telephone client 333a and produces audio output for the telephone client 333a. The voice input is processed using automatic speech recognition, and the audio output is produced using text-to-speech conversion, as is further discussed below.

D. Methodology for Responding Across Multiple Platforms

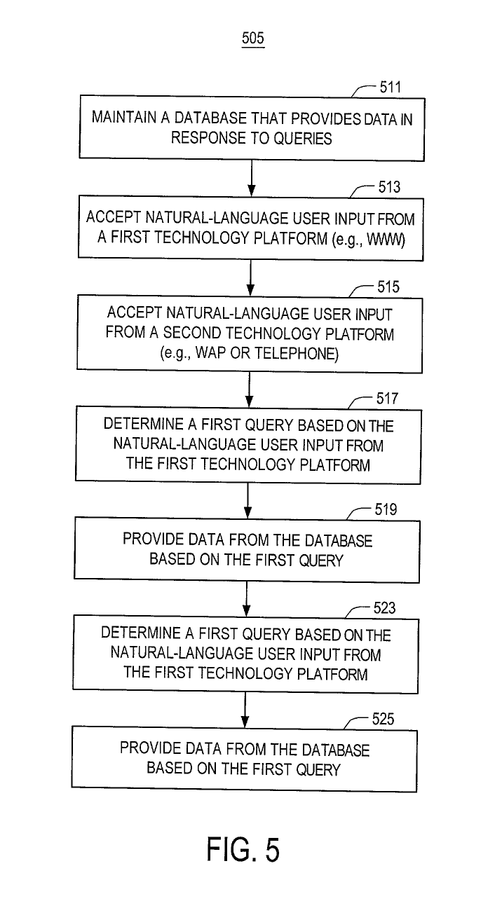

FIG. 5 is a flow diagram that illustrates an exemplary method 505 for responding to user input across multiple platforms. The method 505 includes the following steps: (step 511) maintaining a database that provides data in response to queries; (step 513) accepting natural-language user input from a first technology platform; (step 515) accepting natural-language user input from a second technology platform; (step 517) determining a first query based on the natural-language user input from the first technology platform; (step 519) providing data from the database based on the first query; (step 523) determining a second query based on the natural-language user input from the second technology platform; (step 525) providing data from the database based on the second query.

Preferably, the exemplary method 505 further includes modifying data within the database, and thereafter, providing from the database the modified data in response to natural-language user input from the first technology platform and also providing from the database the modified data in response to natural-language user input from the second technology platform.

V. Further Details of an Exemplary Customer Server for Telephony

A. An Exemplary Customer Server for Telephony

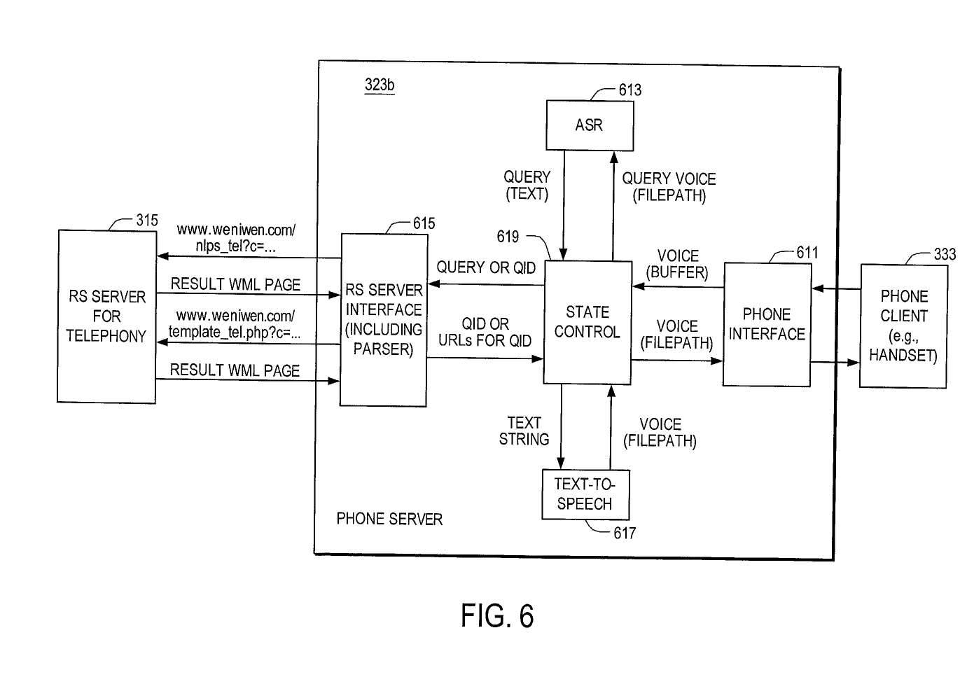

FIG. 6 is a schematic diagram of an embodiment 323b of the telephone customer server 323 or 323a of FIGS. 3 or 4. As shown in FIG. 6, the environment of the phone customer server 323b includes the RS server 315 for telephony and the telephone client 333, which have been discussed in connection with FIG. 3. The telephone customer server 323b includes a telephone interface 611, an automatic speech recognition (ASR) (sub)system 613, an interface 615 that handles interfacing with the RS server 315 for telephony, a conventional text-to-speech converter 617, and a controller 619 for controlling operation of thetelephone customer server 323b.

The telephone interface 611 may include a voice telephony card, such as those available from Dialogic Corp. of Parsippany, N.J., U.S.A. The ASR (sub)system 613 may be a full speech-to-text subsystem, such as the Naturally Speaking speech-recognition system that is available from Dragon Systems, Inc., of Newton, Mass., U.S.A. The ASR (sub)system 613 may alternatively be a speech-recognition system or subsystem, such as those described in the incorporated USER INPUT REFERENCE. For example, the ASR (sub)system 613 may be a system that invokes a separate server, not pictured, to provide speech-to-text recognition services. For another example, the ASR (sub)system 613 may be a limited front-end automatic speech-to-subword recognizer that converts speech to subword units, which are then to be accepted as input by the RS server 315 for telephony for further processing into text.

B. Flow of Information in the Exemplary Customer Server for Telephony

FIG. 6 includes depiction of portions of exemplary information that may be communicated at certain times between elements of the telephone customer server 323b. The depicted exemplary information are not meant to exhaustively list all types of information that may be communicated between elements of the telephone customer server 323b. Information flow in the telephone customer server 323b may be explained using the example user session as conducted by the controller 619: (i) the user interactively speaks into the phone client 333 (e.g., telephone) in response to voice prompts; (ii) the phone interface 611 receives the speech and places it into a buffer; (iii) the user query portion of the speech is sent to the ASR (sub)system 613 and is converted into either a final text form or an intermediate or ambiguous text form; (iv) the resulting query from the ASR (sub)system 613 is sent to the RS server interface 615 and is placed into a form suitable for invoking a response from the RS server 315 for telephony; (v) a response from the RS server 315 for telephony is received, preferably in text form, and is converted into sound form by the text-to-speech converter 617 and is sent to the user via the phone interface 611; (vi) further voice-based interaction proceeds along the same information flow path. The further interaction may, for example, be for the purpose of refining the RS server's understanding of the user's actually-intended query to obtain more-focused information for the user, as was discussed in an earlier section.

C. Supplemental Information in Appendices A and B

Appendix A contains a self-explanatory flow diagram that illustrates a state-based method that may be used by controller 619 to control operation of the telephone customer server 323b. As is shown in Appendix A, in one of the logic states (an “is-first-query” state), notification of an event is received, and: for an event from the telephony interface module, a wave file is passed to the ASR module; for an event from the ASR module, a recognized result is passed to the NLP module (i.e., via the RS Server interface to the NLPS); for an event from the TTS module (i.e., the text-to-speech converter), an output wave file (i.e., sounds) is sent to the telephony interface module.

Appendix B contains schematic diagrams that illustrate two example hardware configurations for implementing the telephone customer server 323b: a mid-range server configuration that is implemented on a single computer system and a large-capacity server that clusters multiple computer systems. The mid-range server may be implemented, for example, on a single PC server to handle up to 8 telephone ports, or more. The PC server may use, for example, a multiple-CPU motherboard with up to two Pentium III processors, or more, running at up to 733 MHz, or more. The PC server includes up to one gigabyte of motherboard RAM, or more, and up to two, or more, 4-port Dialogic voice telephony cards. The large-capacity server may be implemented using multiple telephone servers for interfacing and multiplexing with telephone lines and multiple speech servers for providing ASR services and control. The large-capacity server may be implemented within a single geographic location, or on computers within a same building, or on computers within a same room.

VI. Further Comments

While the invention is described in some detail with specific reference to a single preferred embodiment and certain alternatives, there is no intent to limit the invention to that particular embodiment or those specific alternatives. Thus, the true scope of the present invention is not limited to any one of the foregoing exemplary embodiments but is instead defined by the appended claims.

[image]

[image]

[image]

[image]

[image]

[image]

[image]

[image]

What is claimed is:

1. A system for responding to remotely-entered input, the system comprising:
a database that is configured to retrieve data in response to queries that are based on natural language;
a first server that is configured to accept remotely-entered first natural-language input from a first technology platform and to determine a first query based on the first natural-language input and to obtain data from the database based on the first query; and
a second server that is configured to accept remotely-entered second natural-language input from a second technology platform and to determine a second query based on the second natural-language input and to obtain data from the database based on the second query.

2. The system of claim 1 wherein the first and second servers reside on a single computer system.

3. The system of claim 1 wherein the first natural-language input includes input derived from manually-entered input, and the second natural-language input includes input derived from speech.

4. The system of claim 3 wherein the first natural-language input includes ambiguous input, and, in determining the first query, the first server hypothesizes text as corresponding to the ambiguous input.

5. The system of claim 4 wherein the ambiguous input includes a sequence of Chinese syllables or a sequence of Japanese syllables, and the text corresponds at least in part to a sequence of Chinese or Japanese characters.

6. The system of claim 4 wherein the first technology platform is a World Wide Web platform, the second technology platform is a telephony platform, and the second natural-language input includes input derived from speech spoken into a telephone.

7. The system of claim 1 wherein the first technology platform is a World Wide Web platform, the second technology platform is a telephony platform, and the second natural-language input includes input derived from speech spoken into a telephone.

8. The system of claim 7 further comprising a third server that is configured to accept remotely-entered third natural-language input from a third technology platform, wherein the third technology platform is a platform optimized for wireless applications.

9. A system for responding to remotely-entered input, the system comprising:
a database;
a first server that is configured to accept remotely-entered first input from a first technology platform, wherein the first input includes input derived from manually-entered input, and the manually-entered input is for indicating a user-composed set of words; and
a second server that is configured to accept remotely-entered second input from a second technology platform, wherein the second input includes input derived from speech;
wherein the first server or the second server is configured to recognize words from the first input or from the second input, respectively, and to obtain and output data from the database based on the recognized words.

10. The system of claim 9 wherein the first input is indicative of a sequence of sound units, which sequence can correspond to more than one sequence of Chinese words or Japanese words.

11. The system of claim 10 wherein the first technology platform is a World Wide Web platform, the second technology platform is a telephony platform, the first input includes manually-entered input, and the second input includes input derived from speech spoken into a telephone.

12. The system of claim 9 wherein the first technology platform is a World Wide Web platform, the second technology platform is a telephony platform, and the second input includes input derived from speech spoken into a telephone.

13. The system of claim 12 further comprising a third server that is configured to accept remotely-entered third input from a third technology platform, wherein the third technology platform is a platform optimized for wireless applications.

14. A method for responding to remotely-entered input, the method comprising the steps of:
maintaining a database that is capable of providing stored data in response to queries;
accepting first natural-language user input from a first technology platform;
determining a first query based on the first natural-language input;
providing data from the database based on the first query;
accepting second natural-language user input from a second technology platform;
determining a second query based on the second natural-language input;
providing data from the database based on the second query.

15. The method of claim 14 wherein the first natural-language input includes input derived from manually-entered input, and the second natural-language input includes input derived from speech.

16. The method of claim 15 wherein the first natural-language input includes ambiguous input, and, in determining the first query, the first server hypothesizes text as corresponding to the ambiguous input.

17. The method of claim 16 wherein the ambiguous input includes a sequence of Chinese syllables or a sequence of Japanese syllables, and the text corresponds at least in part to a sequence of Chinese or Japanese characters.

18. The method of claim 16 wherein the first technology platform is a World Wide Web platform, the second technology platform is a telephony platform, and the second natural-language input includes input derived from speech spoken into a telephone.

19. The method of claim 14 wherein:
the step of determining the first query comprises, within a logic state, receiving an event from a telephony interface module, and in response passing a sound file to an automatic speech recognition module; and receiving an event from the automatic speech recognition module, and in response passing a recognized result to a natural language processing module; and
the step of providing data from the database based on the first query comprises receiving an event from a text-to-speech converter, and in response passing a sound file to a telephony interface module.
